(19) United States
(12) Patent Application Publication
(10) Pub. No.: US 2008/0120232 A1
(43) Pub. Date: May 22, 2008

(54) ONLINE CASH REPORTING SYSTEM AND METHOD

(75) Inventors: Daniel Neal Herrin, Katy, TX (US); John Rhoads, Cypress, TX (US)

Correspondence Address: HAYNES AND BOONE, LLP, 901 Main Street, Suite 3100, Dallas, TX, 75202, US

(73) Assignee: LOOMIS ARMORED US, INC., Houston, TX (US)

(21) Appl. No.: 11/839,401

(22) Filed: Aug. 15, 2007

Related U.S. Application Data
(60) Provisional application No. 60/860,620, filed on Nov. 22, 2006.

(51) Int. Cl. G06Q 40/00

(52) U.S. Cl. 705/42; 235/379; 235/487

(57) ABSTRACT

A system for remotely receiving and reporting cash transactions. The system may include a remotely positioned safe, the safe having an automated device configured to authenticate and count cash receipts in the safe, a communication device, and a processor configured to control the authentication, counting, and communicating processes; and a data collection facility in communication with the remotely positioned safe, the data collection facility being configured to poll the remotely positioned safe to determine cash deposits in the safe. The system may further include a reconciliation facility in communication with the data collection facility; and a banking facility in communication with the reconciliation facility, wherein the reconciliation facility is configured to credit a bank account at the banking facility for deposits made in the remotely positioned safe before the contents of the safe are physically delivered to the banking facility.

### CROSS REFERENCE TO RELATED APPLICATIONS

This application claims the benefit of the filing date of U.S. provisional patent application Ser. No. 60/860,620, attorney docket no. 23950.69, filed on Nov. 22, 2006.

### BACKGROUND OF THE DISCLOSURE

1. Field of the Invention

The present invention relates to a system and method for automated cash reporting from a remote location.

2. Description of the Related Art

All business face a universal challenge in converting cash and coins received at a particular business location into recognizable and secure banking assets. There are theft challenges associated with employees and other parties that have access to the cash and coins before it even leaves the business location. There are additional, and often more significant, challenges including theft and logistical challenges associated with physically transporting cash and coins from a business location to a banking location.

Therefore, there is a need for a system or method for securely receiving, identifying/counting, and storing cash and coins collected at a particular business location, securely and safely transporting the received cash and coins to a banking location, while allowing the business to have access to the funds deposited at the business location through a financial institution.

### SUMMARY OF THE DISCLOSURE

Embodiments of the invention may further provide a cash receiving receptacle that may be positioned remotely, i.e., at a business location, where the receptacle is configured to receive cash deposits. The receptacle is configured to authenticate and count cash received, and to communication with a base control system, which may be a bank or financial institution computer. The receptacle is configured to receive and count cash deposited therein, and then communicate the deposit to, for example, the banking institution that holds an account for the business having the receptacle. The banking institution may then credit the businesses' account for the deposit made in the receptacle, despite the fact that the banking institution has not yet actually received the cash deposit at the bank itself. The bank may send an armored truck to periodically pick up the cash deposits, and thereafter, the bank may verify all of the deposits made in the receptacle and create appropriate reports, as required.

Embodiments of the invention may further provide a method for remotely receiving and reporting cash transactions. The method generally includes receiving a cash deposit in a remotely positioned safe, the remotely positioned safe having an automated device for authenticating and counting cash deposits received therein; transmitting a polling information file from the remotely positioned safe to a data collection facility; updating an account record corresponding to the cash deposit; transporting the cash deposit from the remotely positioned safe to a bank; and reconciling the transported cash deposit with the polling information representing the cash deposit received in the remotely positioned safe.

Embodiments of the invention may further provide a system for remotely receiving and reporting cash transactions. The system may include a remotely positioned safe, the safe having an automated device configured to authenticate and count cash receipts in the safe, a communication device, and a processor configured to control the authentication, counting, and communicating processes; and a data collection facility in communication with the remotely positioned safe, the data collection facility being configured to poll the remotely positioned safe to determine cash deposits in the safe. The system may further include a reconciliation facility in communication with the data collection facility; and a banking facility in communication with the reconciliation facility, wherein the reconciliation facility is configured to credit a bank account at the banking facility for deposits made in the remotely positioned safe before the contents of the safe are physically delivered to the banking facility.

Embodiments of the invention may further provide a system for remotely receiving and reporting cash transactions. The system may include receiving means for receiving a cash deposit in a remotely positioned safe, the remotely positioned safe having an automated device for authenticating and counting cash deposits received therein; and transmitting means for transmitting a polling information file from the remotely positioned safe to a data collection facility. The system may further include updating means for updating an account record corresponding to the cash deposit; transporting means for transporting the cash deposit from the remotely positioned safe to a bank; and reconciliation means for reconciling the transported cash deposit with the polling information representing the cash deposit received in the remotely positioned safe.

### BRIEF DESCRIPTION OF THE DRAWINGS

FIG. 1 illustrates an exemplary system configuration of an embodiment of the invention; and

FIG. 2 illustrates an exemplary method of an embodiment of the invention.

### DETAILED DESCRIPTION

The following detailed description generally references exemplary embodiments of the invention. The invention, however, is not limited to any specifically described exemplary embodiment; rather, any combination of the following features and elements, whether related to a described exemplary embodiment or not, may be used to implement and/or practice the invention. Moreover, in various exemplary embodiments, the invention may provide advantages over the prior art; however, although the exemplary embodiments of the invention may achieve advantages over other possible solutions and the prior art, whether a particular advantage is achieved by a given embodiment is not intended in any way to limit the scope of the invention. Thus, the following aspects, features, exemplary embodiments, and advantages are intended to be merely illustrative of the invention and are not considered elements or limitations of the appended claims; except where explicitly recited in a claim. Similarly, references to “the invention,” “Summary of the Invention,” or “Field of the Invention” should neither be construed as a generalization of any inventive subject matter disclosed herein nor considered an element or limitation of the appended claims; except where explicitly recited in a claim.

Further, at least one embodiment of the invention may be implemented as a program product for use with a computer system or other type of processing device or system. The program product may generally be configured to define functions of the embodiments (including the methods) described herein and can be contained on a variety of computer readable media. Illustrative computer readable media include, without limitation, (i) information permanently stored on non-writable storage media (e.g., read-only memory devices within a computer such as CD-ROM disks readable by a CD-ROM drive, or programmable logic devices); (ii) alterable information stored on writable storage media (e.g., floppy disks within a diskette drive or hard-disk drive, writable CD-ROM disks and DVD disks, zip disks, and writable portable memory devices); and (iii) information conveyed across communications media, (e.g., a computer, telephone, wired network, or wireless network). These embodiments also include information shared over the Internet or other computer networks. Therefore, Applicants intend that any computer readable media, when carrying computer-readable instructions that are capable of performing methods or operations associated with the invention when the instructions are executed by a processor, represent an exemplary embodiment of the present invention.

Further still, in general, software routines implementing various elements, parts, or embodiments of the invention may be included as part of a computer operating system or as part of a specific application, component, program, module, object, or sequence of instructions, such as an executable script. Software routines typically include a plurality of instructions capable of being performed using a computer system or other type or processor configured to execute instructions read from a computer readable medium. Also, programs typically include or interface with variables, data structures, other computer programs, etc. that reside in a memory or on storage devices as part of their operation. In addition, various programs described herein may be identified based upon the application for which they are implemented. Those skilled in the art will readily recognize, however, that any particular nomenclature or specific application that follows facilitates a description of the invention and does not limit the invention for use solely with a specific application or nomenclature. Furthermore, the functionality of programs described herein may use a combination of discrete modules or components interacting with one another. Those skilled in the art will recognize, however, that different embodiments may combine or merge such components and modules in a variety of ways not expressly recited in the exemplary embodiments described herein.

Embodiments of the invention generally provide a box equipped with cash and/or coin sorting and electronic identification components. The deposit box, referred to hereinafter as a “safe,” may be remotely positioned at a business location. The safe may include an electronic controller in communication with a financial institution, such as a bank or other financial company, via an internet, telephone, network, satellite, radio, or other communication link or system. The business employees or other persons working at the location where the safe is positioned may insert cash and/or coins (hereinafter referred to as “cash”) collected by the business into the safe, which is configured to automatically receive and count the cash and coins and transmit the determined amount of the deposit into the safe to a bank or other financial institution associated with the business via the communications link. The bank or other financial institution may then credit the amount of the cash remotely deposited into the safe to the business bank account and the business or business owner may have access to the funds before the cash is actually received by the bank or financial institution. The automated detection portion of the safe may further be configured to detect and reject counterfeit, aged, foreign, mutilated, or otherwise un-circulatable currency.

From a business standpoint, a provider of the safe may install the safe at a business location and for a monthly fee may provide maintenance of the safe, cash processing services, and secure transportation of the cash and coins received by the safe to a bank or financial institution. The general operator of the safe (not the business owner, the business that provides the safes and the services associated therewith) may periodically receive information, generally electronically, about the amount of cash received in the machine, and will arrange for secure or armored pick up of the cash when the amount of cash reaches a predetermined threshold or when the safe becomes nearly full.

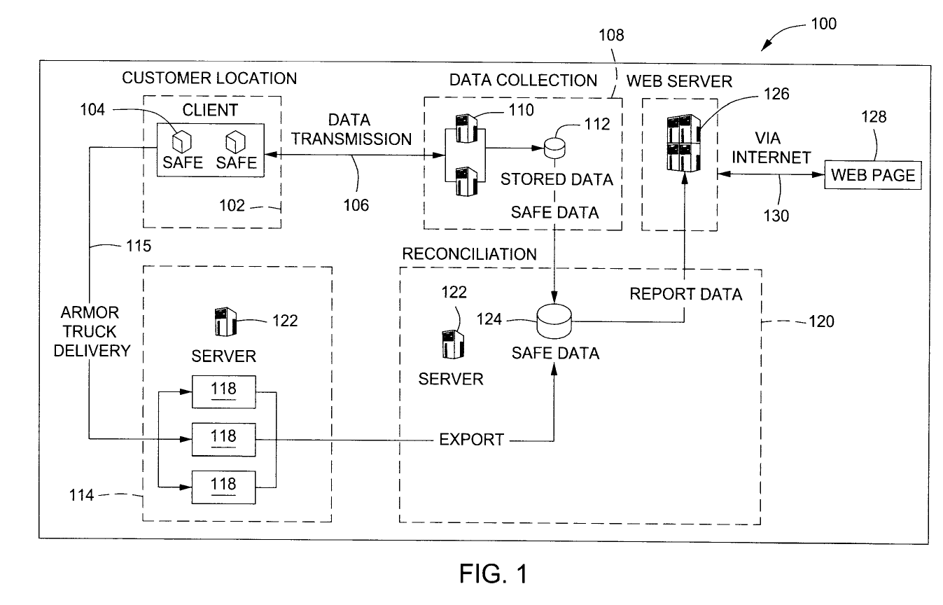

FIG. 1 illustrates an exemplary system configuration of an embodiment of the invention. The system 100 generally includes a customer location 102, which may be a business, where a cash receptacle or safe 104 may be positioned. The safe 104, as noted herein, may include a processing device, a device for authenticating or identifying cash deposits and denominations, a counting device for counting the number of bills deposited, and a communication device configured to communicate with other receptacles 104, data reconciliation systems 110, financial institution computers 116, or any other device capable of receiving information. Thus, cash (or coins) may be deposited in the receptacle 104 by a user, and the cash may be authenticated (to determine the nationality, denomination, etc.) and counted (and possibly sorted in some embodiments) by the receptacle 104. The receptacle 104 may then communicate information related to the deposit to a remote server or other entity.

In the exemplary embodiment illustrated in FIG. 1, the customer location 102 containing at least one receptacle or safe 104 may be in communication with a data collection facility 108, which may also be referred to as a service provider. The communication line 106 may be via a telephone line, a data communication line (cable modem, T1, T2, T3, or other data network line), through an RF transmission network, through a satellite communications system, or through any other available communications device. The data collection facility 108 may include a plurality of servers 110 configured to receive and process financial data, and a data storage 112 for storing data received from various customer locations 102. The data collection facility 108 may also be in communication with a data reconciliation facility 120, that also houses a plurality of servers 122 and a data storage 124. The communication link between the data collection facility 108 and the data reconciliation facility 120 may be similar to the link between the customer location and the data collection facility 108.

The exemplary system may also include a financial institution 114, which may be a banking company that has a plurality of banking locations 118. The financial institution 114 may have a server 116 that communicates with each of the banking locations 118. The server may be in communication with a data storage (not shown). Additionally, the server may be in communication with the data reconciliation facility 120 via a communications link, as described above. The banking facility 114 may be configured to receive a deposits from customers and from the remote receptacles 104. With regard to receiving a deposit from a remote location receptacle 104, generally an armored truck 115, or other secure means of transferring currency, will be dispatched to the remote location 102 and will empty the receptacle 104. The armored truck 115 will then deliver the currency to the financial institution 114. The financial institution 114 will verify the deposits to the receptacle 104 and make any updates or corrections to the business owner's bank account that are necessary.

The deposits that are put into the receptacle 104 are verified and counted, as noted above, and data representative of the deposit is transmitted to the data collection facility 108. The data collection facility 108 updates its database 112 and may transmit data representative of the deposit to the reconciliation facility 120, which may also update its database 124 to reflect the deposit. The financial institution 114 will generally verify the actual deposits received in the receptacle 104 with the data representing the deposit stored in the database 124 of the reconciliation facility. However, Applicants note that embodiments of the invention are not limited to any particular configuration of the data collection facility 108, reconciliation facility 120, and financial institution 114. In fact, Applicants contemplate that the functions of each of these facilities may be combined or separated as desired. Thus, in one embodiment, the customer location 102 may only be in communication with the financial institution 114 and all records of deposits may be reconciled within the financial institution 114, for example.

A web server 126 may also be provided and be in communication with the reconciliation facility (or the banking or data collection facilities) database 124. The web server 126 may be accessible from a web page-based application 128 via the Internet or other computer network 130. Thus, web server 126 provides for remote access to the banking or financial records representative of the deposits received from the receptacle 104.

This system is an improvement upon and a complement to conventional remote deposit capture operations offered by various banking institutions. More particularly, the deposit capture operation allows customers to scan their received checks and electronically submit the scanned information to their bank, which eliminates having to physically transport the received checks to the bank. Deposit capture systems, however, are not configured to physically receive cash, as the scan and send method is not effective for currency. Further, the current remote deposit and capture operations do not provide any sort of onsite validation for currency or onsite pickup of currency, much less both combined with the possibility of crediting a bank account for remote deposits received in a safe before the currency representing the deposit is even removed from the remote safe and taken to the bank.

In at least one embodiment of the invention, an online cash reporting system and method for the verification of currency (cash or coin) deposits into collection receptacles and the reporting of the deposits is provided. A collection receptacle, which may be a safe or other receptacle configured to securely receive currency, can be located in a private or public area and a depositor's use of the system may involve a single collection receptacle or multiple collection receptacles. Once a deposit is made to a collection receptacle, data related to the transaction can be made available for use by a depositor and other designated recipients. The receptacle may include currency inspection and counting devices configured to inspect and count each note or bill received by the receptacle. The receptacle may further include a communication device, such as a microprocessor in communication with communication interface, such as a network interface. The communication interface may be in communication with a network, such as a telephonic internet connection, high speed internet connection, i.e., cable modem, DS1, T1, T2, T3, or satellite communication system. Retrieval of the actual currency deposit can be used to verify the data received from the collection receptacle. Recipients of deposit information may include depositors and designated third parties such as financial institutions. The online cash reporting system may enable a depositor to make currency deposits to a collection receptacle and conduct transactions based on those currency deposits regardless of the actual disposition of the deposited currency.

In at least one exemplary embodiment of the invention, the online cash reporting system operates to collect data on cash deposits made at a collection receptacle, verify and process the data, and generate reports that can be used by a depositor and third parties that are positioned remotely from the collection receptacle. This can be accomplished by using any type of network connection to link collection receptacles to a centralized accounting system configured to communicate with each of the receptacles. At predetermined times or on request, the accounting system may poll a collection receptacle for its deposit data. Deposit data can be exported from the collection receptacle into the accounting system, which can convert the data. The deposit data can also be stored in a database, mapped to a designated recipient's particular data schema, and transmitted to the recipient.

In at least one exemplary embodiment, deposit data can be made available to a secure website for use by a depositor or other designated recipient via secure and/or encrypted connections that may require user names, passwords, or other verification or authentication prior to accessing the website. In another exemplary embodiment, deposit data can be made available to a secure website used by both a depositor and the depositor's financial institution(s). In yet another exemplary embodiment, if a financial institution has an information exchange relationship with an accounting system, the deposit data can be sent directly to a particular financial institution's accounting system. In another exemplary embodiment of the invention, a depositor may be able to use the secure website to remotely configure collection receptacles and access and manipulate deposit data. In some embodiments, a depositor may be able to obtain credit from the financial institution or conduct other financial transactions based on cash deposits that have not been physically retrieved from the collection receptacle(s).

Periodic retrieval of cash deposits from collection receptacles may be carried out by the entity that administers the accounting system or another contractor that provides secure pickup services. The cash deposits may be received by branches of the administering entity, and receipts of cash deposits may be recorded and used to create deposit reports, and the reports may be stored in a database. The deposit reports may be reconciled with the deposit data retrieved from the collection receptacles, over- or under-balances can be noted, and the results of the reconciliation procedures may be stored in a database. Electronic notifications, such as email notifications, to designated recipients may be generated by the accounting system in response to transmissions of deposit data, reconciliation procedures, compilation of deposit reports, or other events. Retrieved cash deposits may subsequently be deposited into the designated financial institution(s). The deposit data stored in the database(s) may be further used to generate reports and status updates related to a depositor's deposit activity and deposit history.

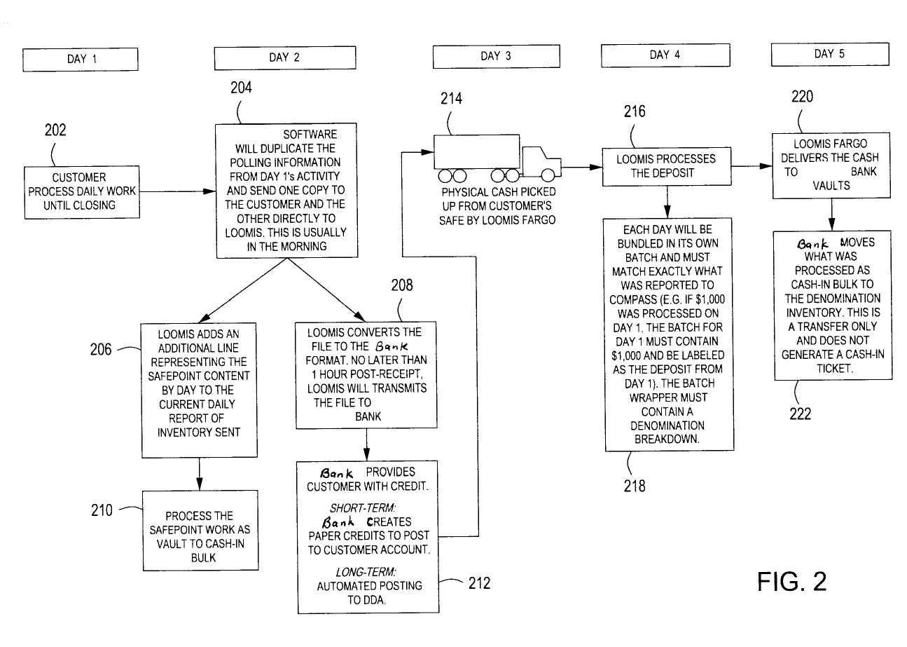

FIG. 2 illustrates an exemplary method of an embodiment of the invention. The exemplary method begins at step 202 where the customer (the entity that has the safe at their location) processes daily customer transactions until closing time. Generally the next day (or after hours on the same business day) the software, which is referred to in the figure as the Edge Software, will duplicate the polling information from the previous business day's activity and send a copy of the activity to the customer and a copy of the activity to Loomis, which for illustrative purposes may be a bank, financial institution, a data processing facility, reconciliation facility, or data collection facility, as illustrated at 204. At 206, Loomis adds an additional line to the data that represents the Safe Point (receptacle 104) content by day to the current daily report of inventory sent to Compass, which may be another bank, clearing house, reconciliation facility, data collection facility, or data processing facility. At step 210, Compass will process the Safe Point work as a vault to cash in bulk transaction. At 208, Loomis converts the data file to the Compass format, which generally happened no later than 1 hour after the receipt, and Loomis transmits the data file to Compass bank. At step 212, Compass provides the customer with credit representative of the deposit, and in the short term, Compass creates paper credits to post to the customer account, while in the long term, automated posting to DDA may be conducted.

At 214, the cash in the receptacle 114 may be physically picked up from the receptacle by an armored truck or other secure means of transporting currency or valuable cargo. At 216, Loomis processes the deposit, and at 218, each business day is bundled in its own batch and will generally match exactly what was reported to Compass. For example, if $1000 was reported as being received by the receptacle 104 on day 1, then the bundle for day 1 retrieved from the receptacle 104 must contain exactly $1000. The wrapper for the bundle may have currency denominations and quantities printed thereon, assuming the receptacle 104 is configured with a device to bundle currency and print identifying information on the bundle. At step 220, Loomis delivers the cash to the Compass bank vaults, and at step 222, Compass moves what was processed as cash-in-bulk to the denomination inventory as a transfer only, which will generally not create a cash-in ticket.

In other exemplary embodiments of the invention, remote collection receptacles may be in communication with an accounting or financial data collection server via a secure virtual private network, such as an Ethernet LAN connection, for example. Further, storage of exported deposit data in a database/database server associated with the data collection server may be provided, and retrieval of deposit data from the data collection server by a managing server via a data collection module which may be configured to convert the retrieved deposit data to the managing server's native data schema. Additionally, embodiments of the invention may provide for application of business rules to and mapping of deposit data to a recipient's data schema by a transmission module prior to sending the deposit data to the recipient. Some exemplary embodiments of the invention may provide for retrieval of transaction logs from remote collection receptacles during retrieval of cash deposits, where the transaction logs may subsequently be used in reconciling the cash deposits with the deposit data retrieved by the managing server. Additionally, conversion of any of the deposit reports, transaction logs, or deposit data, as necessary, to a common data schema for reconciliation procedures may be provided, and storage of reconciliation results in a database within the managing server for subsequent use in generating reports and status updates related to a customer's cash position may be provided by embodiments of the invention.

Embodiments of the invention may also provide for email or other electronic notification of various designated parties upon completion of deposit report compilation, reconciliation of deposit data with cash deposits, transmission of deposit data to the information exchange server, or any other event occurring within any component or device of the system of the invention. Further, generation of cash position reports that are accessible to customers and provide an updated accounting of the customer's cash levels within remote collection receptacles may be generated by embodiments of the invention. Further, an information exchange server to which deposit data is transferred prior to sending the deposit data to recipients may be provided, and database adapters to facilitate transmission of data between modules of the managing server and between the managing server and other servers in the online deposit reporting system may be included in embodiments of the invention. Further still, multiple server adapters for transmission of deposit data to recipients may be provided to accommodate varying recipient data schema and protocols. In any of the embodiments of the invention, business process protocols to manage initiation of procedures and handling of errors within the online cash reporting system may be provided.

In an exemplary embodiment of the invention, a method that includes creating a network having a plurality of remote collection receptacles, collecting deposit data from each remote collection receptacle, retrieving deposits and deposit logs from the remote collection receptacles, generating deposit reports based on the retrieved deposits, converting the deposit data and the data in the deposit logs and deposit reports to a common data schema, reconciling the deposit data, deposit reports, and deposit logs, generating cash position data based on the results of the reconciliation process, converting the cash position data to a data schema acceptable to a particular recipient, and sending the cash position data to the recipient, and notifying the appropriate recipient of operations performed on deposit data, deposit report data, and cash position data may be provided.

In another exemplary embodiment of the invention, the collection receptacle may be in bidirectional communication with other collection receptacles and/or with a central accounting or control system. The bidirectional communication allows for a central accounting or control system to send control messages to the individual receptacles to control the operation thereof. This allows for a central facility to control the operation of the receptacles, e.g., stop or start operation of the receptacle, lock down a receptacle in the event of a fault or theft situation, warn a user of the receptacle of a condition within the receptacle, warn the user of a receptacle of a fault or theft situation occurring at another receptacle, etc. The bi directional communication between receptacles may allow for added security, as a fault or theft attempt at one receptacle may trigger a lockdown at another proximate receptacle. In the event of a theft, the communication capabilities of the receptacles may also be used to send a request for law enforcement either directly to law enforcement, to a centralized control system, or to another receptacle configured to further the process of signaling law enforcement.

In another embodiment of the invention, the receptacle may be configured to receive currency, generally in the form of bills. The bills received by the receptacle may be authenticated or verified by an inspection module, and if approved, the bills may then be sorted. The sort may be into specific denominations, types of currency, etc. Additionally, the receptacle may be configured to redistribute specific types or amounts of bills to the user upon request. In this embodiment, the user may request, generally through a control panel on the receptacle, to remove a particular denomination of bills from the receptacle. The processing and communication systems of the receptacle may be used to authorize the withdrawal. Therefore, in this embodiment of the invention, the receptacle may not only be used to receive secure deposits, but may act as a dispensing machine for currency. This configuration would be advantageous in retail scenarios where a cash drawer could be deposited at the end of a business day, and then at the beginning of a new business day, a withdrawal of a predetermined amount of currency in specific denominations may be used to fill a cash drawer for daily operation. Each of these processes may be monitored and/or controlled by a remote processing or control center, or by a remote terminal where, for example, an owner or manager of the restaurant may approve cash withdrawals.

Applicants note that although only a few exemplary embodiments have been described in detail herein, those skilled in the art will readily appreciate that many modifications are possible in the exemplary embodiments without materially departing from the novel teachings and advantages of this disclosure. Accordingly, all such adjustments and alternatives are intended to be included within the scope of the invention, as defined exclusively in the following claims. Those skilled in the art should also realize that such modifications and equivalent constructions or methods do not depart from the spirit and scope of the present disclosure, and that they may make various changes, substitutions, and alternations herein without departing from the spirit and scope of the present disclosure. Additionally, it is contemplated that any combination of the above noted exemplary embodiments or elements thereof may be used without departing from the scope of the invention, as the invention is not limited to any particular combination of the above noted exemplary embodiments or elements thereof.

What is claimed is:

1. A method for remotely receiving and reporting cash transactions, comprising:
receiving a cash deposit in a remotely positioned safe, the remotely positioned safe having an automated device for authenticating and counting cash deposits received therein;
transmitting a polling information file from the remotely positioned safe to a data collection facility;
updating an account record corresponding to the cash deposit;
transporting the cash deposit from the remotely positioned safe to a bank; and
reconciling the transported cash deposit with the polling information representing the cash deposit received in the remotely positioned safe.

2. The method of claim 1, wherein the reconciling is conducted after the updating.

3. The method of claim 1, wherein receiving the cash deposit further comprises bundling, in the remotely positioned safe, the cash deposit and marking the bundle to represent the amount of cash in the bundle.

4. The method of claim 1, further comprising transmitting a safe full message from the remotely positioned safe to a collection facility when the remotely positioned safe is near full capacity.

5. The method of claim 4, further comprising dispatching a secure or armored vehicle to pick up a plurality of cash deposits when the remotely positioned safe is near full.

6. The method of claim 1, wherein reconciling comprises comparing the transmitted polling information to the cash deposit transmitted from the remotely positioned safe.

7. The method of claim 1, further comprising a web server in communication with a database that houses the account record, the web server being configured to allow secure access to the database via a web page.

8. A system for remotely receiving and reporting cash transactions, comprising:
a remotely positioned safe, the safe having an automated device configured to authenticate and count cash receipts in the safe, a communication device, and a processor configured to control the authentication, counting, and communicating processes;
a data collection facility in communication with the remotely positioned safe, the data collection facility being configured to poll the remotely positioned safe to determine cash deposits in the safe;
a reconciliation facility in communication with the data collection facility; and
a banking facility in communication with the reconciliation facility, wherein the reconciliation facility is configured to credit a bank account at the banking facility for deposits made in the remotely positioned safe before the contents of the safe are physically delivered to the banking facility.

9. The system of claim 8, wherein the safe and respective facilities are in communication with each other via a bidirectional communications link.

10. The system of claim 8, wherein the data collection facility is configured to order a secure vehicle to empty the remotely positioned safe when the remotely positioned safe indicates that it is full.

11. The system of claim 8, further comprising a web server in communication with a database in the reconciliation facility, the web server being configured to allow for web-based access to data representative of funds deposited into the bank account from the remotely positioned safe.

12. The system of claim 8, wherein the remotely positioned safe further comprises sorting device configured to sort currency received in the safe by denomination.

13. The system of claim 8, wherein the remotely positioned safe further comprises wrapping and printing device configured to wrap bundles of currency in the remotely positioned safe and print an identifier for the currency contained in the bundle onto a wrap of the bundle.

14. A system for remotely receiving and reporting cash transactions, comprising:
receiving means for receiving a cash deposit in a remotely positioned safe, the remotely positioned safe having an automated device for authenticating and counting cash deposits received therein;
transmitting means for transmitting a polling information file from the remotely positioned safe to a data collection facility;
updating means for updating an account record corresponding to the cash deposit;
transporting means for transporting the cash deposit from the remotely positioned safe to a bank; and
reconciliation means for reconciling the transported cash deposit with the polling information representing the cash deposit received in the remotely positioned safe.

15. The system of claim 14, wherein the reconciling is conducted after the updating.

16. The system of claim 14, further comprising transmitting means for transmitting a safe full message from the remotely positioned safe to a collection facility when the remotely positioned safe is near full capacity.

17. The system of claim 16, further comprising dispatching means for dispatching a secure or armored vehicle to pick up a plurality of cash deposits from the remotely positioned safe in response to the transmitted safe full message.

18. The system of claim 14, further comprising a web server means for communicating via the Internet in communication with a database that houses the account record, the web server being configured to allow secure access to the database via a web page.

19. A computer program embodied on a computer readable medium, that when executed by a processor, is configured to control a method for remotely receiving and reporting cash transactions, the method comprising:
receiving a cash deposit in a remotely positioned safe, the remotely positioned safe having an automated device for authenticating and counting cash deposits received therein;
transmitting a polling information file from the remotely positioned safe to a data collection facility;
updating an account record corresponding to the cash deposit before a reconciling process is conducted with an actual cash deposit in a financial institution;
transporting the cash deposit from the remotely positioned safe to a bank; and
reconciling, after the transporting, the transported cash deposit with the polling information representing the cash deposit received in the remotely positioned safe.

20. The computer program of claim 19, wherein reconciling comprises comparing the transmitted polling information to the cash deposit transmitted from the remotely positioned safe.

21. The computer program of claim 19, wherein receiving the cash deposit further comprises bundling, in the remotely positioned safe, the cash deposit and marking the bundle to represent the amount of cash in the bundle.
